(19) United States
(12) Patent Application Publication
(10) Pub. No.: US 2026/0141489 A1
(43) Pub. Date: May 21, 2026

(54) TRAINING MACHINE LEARNING-BASED MULTI-FRAME BLENDING WITH SIMULATED WARPING AND HANDHELD MOTION AUGMENTATIONS

(71) Applicant: Samsung Electronics Co., Ltd., Suwon-si (KR)

(72) Inventors: Thilo Balke, Plano, TX (US); Ke Wang, San Jose, CA (US); Abhiram Gnanasambandam, Frisco, TX (US); John Seokjun Lee, Allen, TX (US); Hamid R. Sheikh, Allen, TX (US)

(21) Appl. No.: 18/955,824

(22) Filed: Nov. 21, 2024

(51) Int. Cl. G06T 5/60; G06T 3/18; G06T 5/70; G06T 5/73

(52) U.S. Cl. CPC G06T 5/60; G06T 3/18; G06T 5/70; G06T 5/73; G06T 2207/20081

(57) ABSTRACT

A method includes obtaining, using at least one processing device of an electronic device, multiple sets of training image frames, where each set of training image frames has an associated ground truth image. The method also includes applying, using the at least one processing device, motion blur and warping to the multiple sets of training image frames in order to generate additional sets of training image frames. In addition, the method includes training, using the at least one processing device, a machine learning model to align image frames and remove motion blur from the image frames based on at least the additional sets of training image frames and the ground truth images.

### TECHNICAL FIELD

This disclosure relates generally to machine learning systems and processes. More specifically, this disclosure relates to training machine learning-based multi-frame blending with simulated warping and handheld motion augmentations.

### BACKGROUND

Many mobile electronic devices, such as smartphones and tablet computers, include cameras that can be used to capture still and video images. Multi-frame imaging is a technique that is often employed by mobile electronic devices and other image capture devices. In multi-frame imaging, multiple image frames of a scene are captured at or near the same time, and the image frames are blended or otherwise combined to produce a final image of the scene. This approach can help to significantly improve the visual quality of the final images.

### SUMMARY

This disclosure relates to training machine learning-based multi-frame blending with simulated warping and handheld motion augmentations

In a first embodiment, a method includes obtaining, using at least one processing device of an electronic device, multiple sets of training image frames, where each set of training image frames has an associated ground truth image. The method also includes applying, using the at least one processing device, motion blur and warping to the multiple sets of training image frames in order to generate additional sets of training image frames. In addition, the method includes training, using the at least one processing device, a machine learning model to align image frames and remove motion blur from the image frames based on at least the additional sets of training image frames and the ground truth images. A non-transitory machine-readable medium may include instructions that when executed cause at least one processor to perform the method of the first embodiment.

In a second embodiment, an apparatus includes at least one processing device configured to obtain multiple sets of training image frames, where each set of training image frames has an associated ground truth image. The at least one processing device is also configured to apply motion blur and warping to the multiple sets of training image frames in order to generate additional sets of training image frames. In addition, the at least one processing device is configured to train a machine learning model to align image frames and remove motion blur from the image frames based on at least the additional sets of training image frames and the ground truth images.

In a third embodiment, a method includes obtaining, using at least one processing device of an electronic device, a set of input image frames capturing a scene. The method also includes processing, using the at least one processing device, the set of input image frames using a trained machine learning model to align the input image frames and reduce motion blur in the input image frames in order to generate processed image frames. In addition, the method includes generating, using the at least one processing device, an output image of the scene using the processed image frames. The trained machine learning model is trained by obtaining multiple sets of training image frames (each set of training image frames having an associated ground truth image), applying motion blur and warping to the multiple sets of training image frames in order to generate additional sets of training image frames, and training the machine learning model based on at least the additional sets of training image frames and the ground truth images. An apparatus may include at least one processing device configured to perform the method of the third embodiment. A non-transitory machine-readable medium may include instructions that when executed cause at least one processor to perform the method of the third embodiment.

Any one or any combination of the following features may be used with the first, second, or third embodiment. The motion blur may be applied by, for each set of training image frames, identifying noise in the associated ground truth image, removing the identified noise from the training image frames in the set of training image frames in order to generate denoised image frames, applying one or more random blur kernels to each of the denoised image frames in order to generate blurred image frames, and adding the identified noise to the blurred image frames. Each of the training image frames may include image data in multiple color channels, and the one or more random blur kernels may be applied to each color channel of each training image frame. The one or more random blur kernels may be applied to each of the denoised image frames by selecting an orientation and strength of motion to be created in each of the denoised image frames and defining the one or more random blur kernels for each of the denoised image frames based on the corresponding orientation and strength of motion. The warping may be applied by, for each set of training image frames, generating a warp field for each of a subset of the training image frames and applying the generated warp fields to the subset of the training image frames. Each warp field may define that each pixel of an image frame is warped independently of other pixels but neighboring pixels of the image frame are warped with a same or similar direction and a same or similar strength. The warp field for each of the subset of the training image frames may be generated by generating white Gaussian noise and applying a linear two-dimensional (2D) Gaussian blur operator and normalization to the white Gaussian noise. The training image frames may capture different static scenes, and the ground truth images may include long-exposure images of the static scenes. The additional sets of training image frames may simulate inter-frame motion and inter-frame misalignment.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings:

FIG. 1 illustrates an example network configuration including an electronic device in accordance with this disclosure;

FIG. 2 illustrates an example pipeline that supports machine learning-based multi-frame blending in accordance with this disclosure;

FIGS. 3 and 4 illustrate example architectures that support training a machine learning model to perform multi-frame blending with simulated warping and handheld motion augmentations in accordance with this disclosure;

FIGS. 5A and 5B illustrate an example technique for applying motion blur in accordance with this disclosure;

FIG. 6 illustrates an example technique for applying warping in accordance with this disclosure;

FIGS. 7 through 9 illustrate example processing of multi-color channel image frames during training and use of a machine learning model in accordance with this disclosure;

FIGS. 10A and 10B illustrate example results obtainable using a machine learning model trained to perform multi-frame blending with simulated warping and handheld motion augmentations in accordance with this disclosure;

FIG. 11 illustrates an example method for training a machine learning model to perform multi-frame blending with simulated warping and handheld motion augmentations in accordance with this disclosure; and

FIG. 12 illustrates an example method for using a trained machine learning model to perform multi-frame blending in accordance with this disclosure.

### DETAILED DESCRIPTION

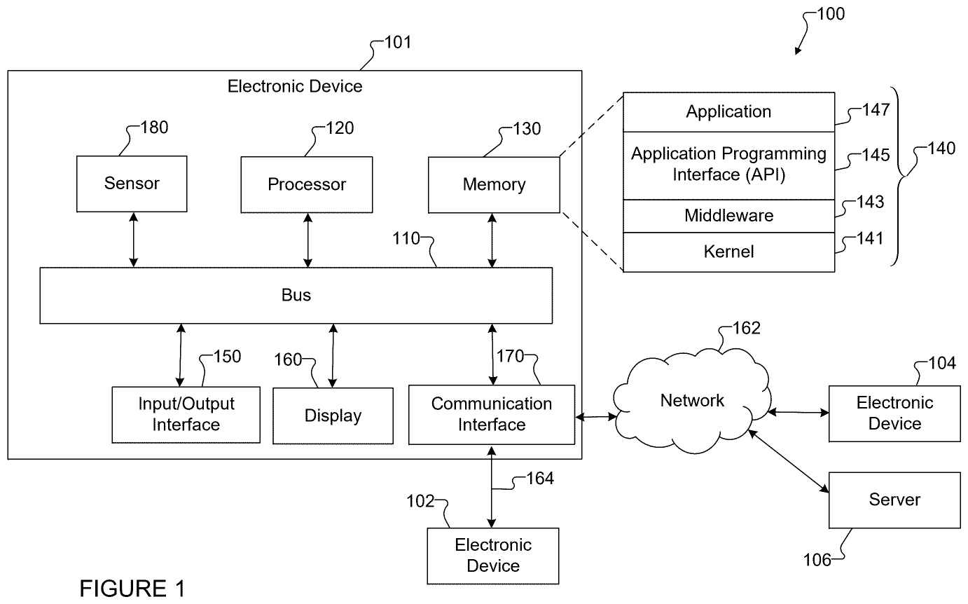

FIGS. 1 through 12, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure.

As noted above, many mobile electronic devices, such as smartphones and tablet computers, include cameras that can be used to capture still and video images. Multi-frame imaging is a technique that is often employed by mobile electronic devices and other image capture devices. In multi-frame imaging, multiple image frames of a scene are captured at or near the same time, and the image frames are blended or otherwise combined to produce a final image of the scene. This approach can help to significantly improve the visual quality of the final images.

Unfortunately, many mobile electronic devices are handheld devices, and movement of handheld devices is common during image capture (such as due to movement of a user's hand or body). Because of this, image frames that are captured by handheld devices and blended together typically have some form of misalignment and motion blur. Even though functions such as image alignment and deblurring can be performed, these approaches can still allow some residual misalignment and motion blur to remain, which can negatively impact the images generated by blending the image frames. In some cases, this may be particularly noticeable during nighttime image capture or during image capture in other low-light situations, where inter-frame misalignment and motion blur tend to be more significant due to longer exposure times.

This disclosure provides various techniques related to training and using a machine learning model to perform multi-frame blending, where the machine learning model is trained using simulated warping and handheld motion augmentations. For example, as described in more detail below, multiple sets of training image frames can be obtained, and each set of training image frames can have an associated ground truth image. Motion blur and warping can be applied to the multiple sets of training image frames in order to generate additional sets of training image frames. A machine learning model can be trained to align image frames and remove motion blur from the image frames based on at least the additional sets of training image frames and the ground truth images.

After the training, the trained machine learning model can be deployed and placed into use. For example, a set of input image frames capturing a scene can be obtained. The set of input image frames can be processed using the trained machine learning model to align the input image frames and reduce motion blur in the input image frames in order to generate processed image frames. An output image of the scene can be generated using the processed image frames, such as by performing multi-frame blending of the processed image frames.

In this way, the described techniques support more effective training of machine learning models that can be used to provide improved multi-frame blending. For example, a machine learning model may be trained to more effectively remove misalignment and motion blur from image frames, thereby allowing blended images having higher image quality to be generated using those image frames. Moreover, these approaches can help to increase the amount of training data available for training the machine learning models, which can reduce the amount of training data that needs to be collected and/or improve the accuracy of the trained machine learning models.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described below, the processor 120 may train and/or use a machine learning model for multi-frame blending.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, train and/or use a machine learning model for multi-frame blending. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the one or more sensors 180 can include one or more cameras or other imaging sensors, which may be used to capture images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, that includes one or more imaging sensors.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may train and/or use a machine learning model for multi-frame blending.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

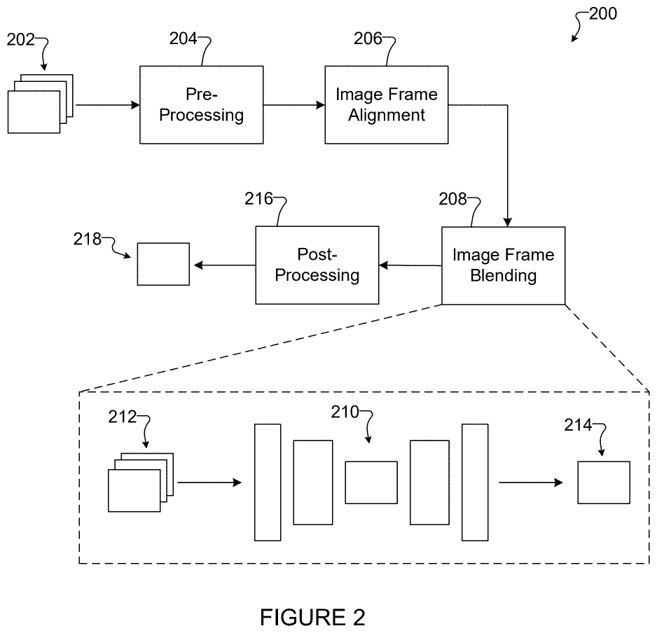

FIG. 2 illustrates an example pipeline 200 that supports machine learning-based multi-frame blending in accordance with this disclosure. For ease of explanation, the pipeline 200 shown in FIG. 2 is described as being implemented on or supported by the electronic device 101 in the network configuration 100 of FIG. 1. However, the pipeline 200 shown in FIG. 2 could be used with any other suitable device(s) and in any other suitable system(s), such as when the pipeline 200 is implemented on or supported by the server 106.

As shown in FIG. 2, the pipeline 200 generally receives and processes multiple input image frames 202. The input image frames 202 may include image frames captured in rapid succession or at substantially the same time. The input image frames 202 may be obtained from any suitable source(s), such as when the input image frames 202 are captured using at least one camera or other imaging sensor 180 of the electronic device 101 during an image capture operation. Depending on the implementation, a single imaging sensor 180 may be used to capture the input image frames 202, or multiple imaging sensors 180 may be used to capture the input image frames 202.

In some embodiments, the input image frames 202 represent raw image frames. Raw image frames typically refer to image frames that have undergone little if any processing after being captured. The availability of raw image frames can be useful in a number of circumstances since the raw image frames can be subsequently processed to achieve the creation of desired effects in output images. In many cases, for example, the input image frames 202 can have a wider dynamic range or a wider color gamut that is narrowed during image processing operations in order to produce still or video image frames suitable for display or other use. The input image frames 202 here may include any suitable number of input image frames 202. Each input image frame 202 can have any suitable format, such as a Bayer or other raw image format, a red-green-blue (RGB) image format, or a luma-chroma (YUV) image format. Each input image frame 202 can also have any suitable resolution, such as up to fifty megapixels or more.

In some embodiments, the input image frames 202 include image frames captured using different capture conditions. The capture conditions can represent any suitable settings of the electronic device 101 or other device used to capture the input image frames 202. For example, the capture conditions may represent different exposure settings of the imaging sensor(s) 180 used to capture the input image frames 202, such as different exposure times or ISO settings. In multi-frame processing pipelines, multiple input image frames 202 can be captured using different exposure settings so that portions of different input image frames 202 can be combined to produce an HDR output image or other blended image.

The input image frames 202 are processed using various operations in the pipeline 200. For example, each input image frame 202 may be provided to a pre-processing operation 204, which can pre-process the input image frames 202 in order to prepare the input image frames 202 for subsequent blending. The pre-processing operation 204 may include any suitable image processing operation(s). In some embodiments, for instance, the pre-processing operation 204 may include a white balance operation in which image color adjustments are made in order to modify the white balance of each input image frame 202, such as to remove color casts or achieve desired color temperatures. The pre-processing operation 204 may also or alternatively include a denoising operation in which the input image frames 202 are processed to remove noise from the image frames. Note that the pre-processing operation 204 may include any other or additional image processing operation or operations as needed or desired.

The pre-processed versions of the input image frames 202 may be provided to an image frame alignment operation 206, which generally operates to modify one or more of the image frames in order to generate aligned versions of the image frames. For example, the image frames may undergo alignment so that common features in different image frames are at the same or substantially the same locations in the aligned versions of the image frames. In some embodiments, the image frame alignment operation 206 may select a reference image frame and modify one or more non-reference image frames so as to be aligned with the reference image frame. In some cases, for instance, the image frame alignment operation 206 generates a warp or alignment map for each non-reference image frame, where each warp or alignment map includes or is based on one or more motion vectors that identify how the position(s) of one or more specific features in the associated non-reference image frame should be altered in order to be in the position(s) of the same feature(s) in the reference image frame. The image frame alignment operation 206 may use any suitable technique(s) for image alignment, which is also sometimes referred to as image registration. In some embodiments, the image frames can be aligned both geometrically and photometrically. In particular embodiments, the image frame alignment operation 206 can use global Oriented FAST and Rotated BRIEF (ORB) features and local features from a block search to identify how to align the image frames. Note, however, that this disclosure is not limited to any particular technique(s) for aligning image frames.

The aligned versions of the input image frames 202 may be provided to an image frame blending operation 208, which generally operates to combine image data contained in the aligned image frames. For example, the image frame blending operation 208 may be implemented using a trained machine learning model 210, such as a machine learning model that includes various convolutional layers and other layers. In some embodiments, the trained machine learning model 210 of the image frame blending operation 208 can combine image data from aligned image frames 212 and generate a blended image 214 based on the aligned image frames 212. During this process, the trained machine learning model 210 of the image frame blending operation 208 can reduce or minimize any residual misalignment and motion blur remaining in those image frames. Details of example embodiments of the image frame blending operation 208 and the machine learning model 210 are provided below.

The blended image 214 generated by the image frame blending operation 208 may be provided to a post-processing operation 216, which can further process the blended image 214 in order to generate an output image 218. The output image 218 may represent a final image of the scene captured in the input image frames 202. The post-processing operation 216 may include any suitable image processing operation(s). In some embodiments, for instance, the post-processing operation 216 may include a tone mapping operation in which colors in the blended image 214 are adjusted. This can be useful or important in various applications, such as when generating HDR images. For example, since generating an HDR image often involves capturing multiple images of a scene using different exposures and combining the captured images to produce the HDR image, this type of processing can often result in the creation of unnatural tone within the HDR image. The post-processing operation 216 can therefore use one or more color mappings to adjust the colors contained in the blended images. The post-processing operation 216 may also or alternatively include a demosaicing operation in which a multi-color channel blended image 214 is converted into a full-color image. Note that the post-processing operation 216 may include any other or additional image processing operation or operations as needed or desired.

Although FIG. 2 illustrates one example of a pipeline 200 that supports machine learning-based multi-frame blending, various changes may be made to FIG. 2. For example, various components or operations in FIG. 2 may be combined, further subdivided, replicated, rearranged, or omitted according to particular needs. Also, various additional components or functions may be used in FIG. 2. In addition, the specific pipeline 200 described above is for illustration and explanation only. Various image processing pipelines have been developed, and additional image processing pipelines are sure to be developed in the future. This disclosure is not limited to any specific implementation of an pipeline 200 or even to use within an image processing pipeline. In general, the techniques for machine learning-based multi-frame blending described in this patent document may be used in any other image processing pipeline or other architecture.

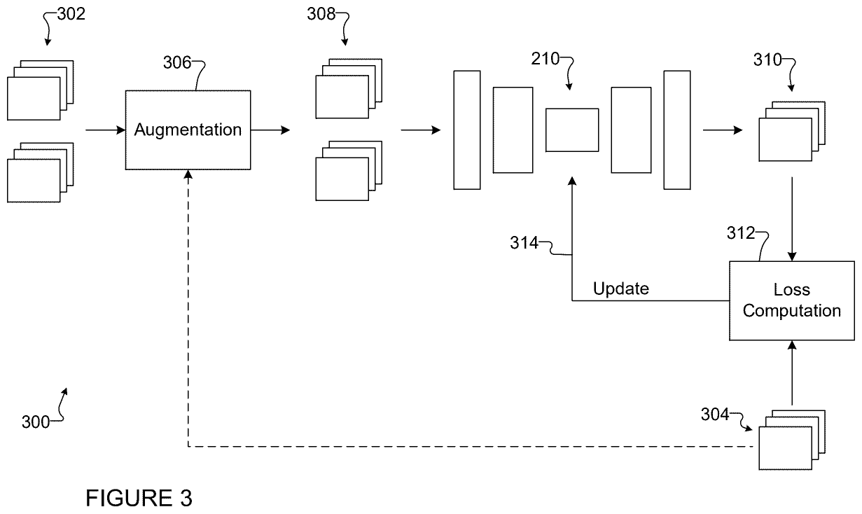

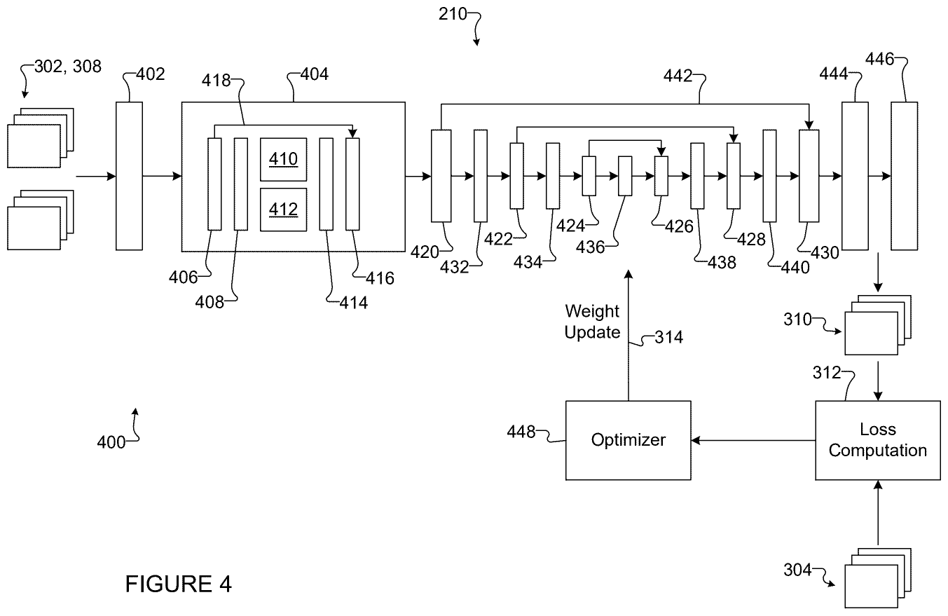

FIGS. 3 and 4 illustrate example architectures 300, 400 that support training a machine learning model to perform multi-frame blending with simulated warping and handheld motion augmentations in accordance with this disclosure. For case of explanation, the architectures 300, 400 shown in FIGS. 3 and 4 are described as being implemented on or supported by the server 106 in the network configuration 100 of FIG. 1. However, the architectures 300, 400 shown in FIGS. 3 and 4 could be used with any other suitable device(s) and in any other suitable system(s), such as when the architectures 300, 400 are implemented on or supported by the electronic device 101. The architectures 300, 400 may also be used to train any suitable machine learning model, such as when the architectures 300, 400 are used to train the machine learning model 210 for use in the image frame blending operation 208 of the pipeline 200.

As shown in FIG. 3, the architecture 300 generally operates to receive and process multiple sets 302 of training image frames. Each set 302 of training image frames includes two or more image frames. Each set 302 of training image frames may capture any suitable scene. In some embodiments, the various sets 302 of training image frames can capture a number of static scenes in which there is little if any motion within the scenes themselves. In some cases, the sets 302 of training image frames may represent shorter-exposure image frames of static scenes, which may help to reduce or minimize intra-frame and inter-frame blurring caused by motion within the captured scenes.

Each set 302 of training image frames has an associated ground truth image 304. Each ground truth image 304 represents an image that should be generated by the machine learning model 210 when blending the training image frames in the associated set 302 of training image frames. In other words, each ground truth image 304 represents the desired output of the machine learning model 210 being trained. Each ground truth image 304 may be generated in any suitable manner, such as by blending multiple longer-exposure image frames of the associated scene. The ground truth images 304 are generally of higher quality than their associated training image frames, such as when each ground truth image 304 has a higher signal-to-noise ratio (SNR) and contains more scene details compared to each associated training image frame in the corresponding set 302 of training image frames.

In some cases, the sets 302 of training image frames and the corresponding ground truth images 304 may be created, such as by taking a number of higher-resolution images of static scenes and cropping the higher-resolution images to generate many more smaller image patches. As a particular example, thousands of 4K-resolution images may be cropped in various ways to generate tens of thousands of 1024×1024 image patches or other image patches suitable for use during training.

An augmentation operation 306 generally operates to process the sets 302 of training image frames and generate augmented sets 308 of training image frames. The augmented sets 308 of training image frames represent additional sets of training image frames that can be used during training of the machine learning model 210. Because the sets 302 of training image frames can capture static scenes, the augmentation operation 306 can be used to artificially introduce misalignment and motion blur that may normally occur during image capture operations (such as due to user movement). Among other things, the augmentation operation 306 can perform motion blur augmentation and warping augmentation to create misalignment and motion between the training image frames in each set 302 of training image frames.

In some embodiments, the augmentation operation 306 can utilize the ground truth images 304 during motion blur augmentation. For example, the augmentation operation 306 can estimate the noise contained in each ground truth image 304, and the augmentation operation 306 can use the estimated noise in order to handle the noise separately from motion blur. As a particular example, for each set 302 of training image frames, the augmentation operation 306 may identify the noise in the associated ground truth image 304, remove the identified noise from the training image frames in the set 302 of training image frames, apply blurring (such as by using one or more random blur kernels) to each of the resulting denoised image frames, and add the identified noise back into the resulting blurred image frames. This allows the machine learning model 210 to be trained using image frames having expected noise, meaning noise that may be experienced during actual use of the machine learning model 210 after deployment. As described below, parameters like the probability and strength of motion can be randomly generated and used to create the blur kernels that are applied during the motion blur augmentation.

Also, in some embodiments, the augmentation operation 306 can warp all but a specified image frame (such as the first image frame) in each set 302 of training image frames during warping augmentation. For example, for each set 302 of training image frames, the augmentation operation 306 can generate a warp field for each of a subset of the training image frames in the set 302 of training image frames. The augmentation operation 306 can apply the generated warp fields to the subset of the training image frames in order to generate warped image frames, thereby simulating misalignment of the training image frames. In some embodiments, each warp field defines that (i) each pixel of an image frame is warped independently of other pixels and (ii) neighboring pixels of the image frame are warped with a same or similar direction and a same or similar strength (locality). In particular embodiments, each warp field is produced by generating white Gaussian noise and applying a linear two-dimensional (2D) Gaussian blur operator and normalization to the white Gaussian noise. As described below, parameters like the direction and strength/locality can be randomly generated and used during the warping augmentation.

In this way, it is possible to incorporate features that simulate motion while preserving noise statistics of the sets 302 of training image frames and the ground truth images 304 when generating the augmented sets 308 of training image frames. Also, as described below, color filter array (CFA) patterns (such as a Bayer pattern) may be preserved during the generation of the augmented sets 308 of training image frames. Note that each set 302 of training image frames may be used to generate any suitable number of augmented sets 308 of training image frames. In some cases, for instance, each set 302 of training image frames may be used to generate multiple augmented sets 308 of training image frames, such as by using different motion blur augmentation parameters (such as different probability and/or strength of motion value) and/or different warping augmentation parameters (such as different direction and/or strength/locality values) to generate the augmented sets 308 of training image frames.

During training, at least the augmented sets 308 of training image frames (and optionally the sets 302 of training image frames) are provided to the machine learning model 210. The machine learning model 210 processes each set of training image frames and generates a corresponding blended image 310. A loss computation operation 312 compares each blended image 310 against its corresponding ground truth image 304, such as to identify differences between the blended image 310 and the corresponding ground truth image 304. These differences can be used to calculate a loss of the machine learning model 210, and this can be repeated across any number of blended images 310 and corresponding ground truth images 304. The loss computation operation 312 may calculate any suitable measure of loss for the machine learning model 210 here, such as an L₁ loss.

When the resulting loss of the machine learning model 210 exceeds a threshold value, an update process 314 can be performed to update weights or other parameters of the machine learning model 210. Any suitable process may be used here to update the weights or other parameters of the machine learning model 210, such as stochastic gradient descent, back-propagation, or other suitable technique(s). The modified machine learning model 210 can be used to process the same or different augmented sets 308 of training image frames (and optionally the same or different sets 302 of training image frames) in order to generate additional blended images 310, which can be compared to their corresponding ground truth images 304 to generate an updated loss. This process can occur repeatedly any number of times until one or more criteria are satisfied, such as the updated loss being below the threshold value, a specified number of training iterations occurring, or a specified amount of training time elapsing.

The architecture 400 shown in FIG. 4 uses a similar process for training the machine learning model 210. However, FIG. 4 provides a specific example implementation of the machine learning model 210. In this example, at least the augmented sets 308 of training image frames (and optionally the sets 302 of training image frames) can be generated as described above. The sets of training image frames are processed using a convolutional layer 402, such as a 3×3 convolutional layer. Outputs of the convolutional layer 402 are processed using a Swin-Conv (SC) block 404. The Swin-Conv block 404 includes a convolutional layer 406, such as a 1×1 convolutional layer. A split layer 408 divides the resulting features from the convolutional layer 406, such as by dividing the features evenly into two feature maps. One feature map can be processed using a Swin transformer (SwinT) 410, and another feature map can be processed using a residual block 412. In some cases, the residual block 412 may represent a 3×3 convolutional layer. A concatenation layer 414 combines outputs from the Swin transformer 410 and the residual block 412, and the combined outputs are processed by a convolutional layer 416, such as a 1×1 convolutional layer. A skip connection 418 can be used to provide features generated by the convolutional layer 406 directly to the convolutional layer 416.

Outputs of the Swin-Conv block 404 are provided to a U-Net architecture that includes a number of layers that provide downscaling and then upscaling. In this example, the U-Net architecture includes strided convolutional layers 420-424, strided transposed convolutional layers 426-430, and additional Swin-Conv blocks 432-440. Each of the strided convolutional layers 420-424 represents a convolutional layer that can process feature maps using a stride, such as a 2×2 stride. Each of the strided transposed convolutional layers 426-430 represents a convolutional layer that can process feature maps using a stride, such as a 2×2 stride, but in a transposed manner relative to a corresponding strided convolutional layer 420-424. Each of the additional Swin-Conv blocks 432-440 can have the same structure as the Swin-Conv block 404. Skip connections 442 can be used to provide features generated by the strided convolutional layers 420-424 directly to the corresponding strided transposed convolutional layers 426-430. Outputs from the strided transposed convolutional layer 430 are provided to a final Swin-Conv block 444, which can have the same structure as the Swin-Conv block 404. Outputs from the Swin-Conv block 444 are processed using a convolutional layer 446, such as a 3×3 convolutional layer. The convolutional layer 446 produces the blended images 310.

This model architecture for the machine learning model 210 effectively incorporates Swin-Conv blocks, each of which enables local modeling through residual convolution layers and non-local modeling through a transformer block. This is combined with a multi-scale U-Net architecture, which can effectively perform downscaling (using the layers 420-424 and 432-436) and upscaling (using the layers 426-430 and 436-440).

The loss computation operation 312 compares each blended image 310 against its corresponding ground truth image 304 to calculate a loss for the machine learning model 210. In this example, the loss computation operation 312 provides the loss to an optimizer 448, which can determine how to adjust weights of the various layers in the machine learning model 210. The optimizer 448 can use any suitable technique to determine how to adjust the weights of the machine learning model 210, such as stochastic gradient descent (in some cases with batch sizes of about four to sixteen image patches). The weights of the various layers in the machine learning model 210 are updated during the update process 314, and another training iteration may occur using the updated weights.

Although FIGS. 3 and 4 illustrate examples of architectures 300, 400 that support training a machine learning model 210 to perform multi-frame blending with simulated warping and handheld motion augmentations, various changes may be made to FIGS. 3 and 4. For example, various components or operations in each of FIGS. 3 and 4 may be combined, further subdivided, replicated, rearranged, or omitted according to particular needs. Also, various additional components or functions may be used in each of FIGS. 3 and 4. In addition, the machine learning model 210 may have any other suitable machine learning architecture that can be trained to perform multi-frame blending using training image frames having simulated warping and handheld motion augmentations.

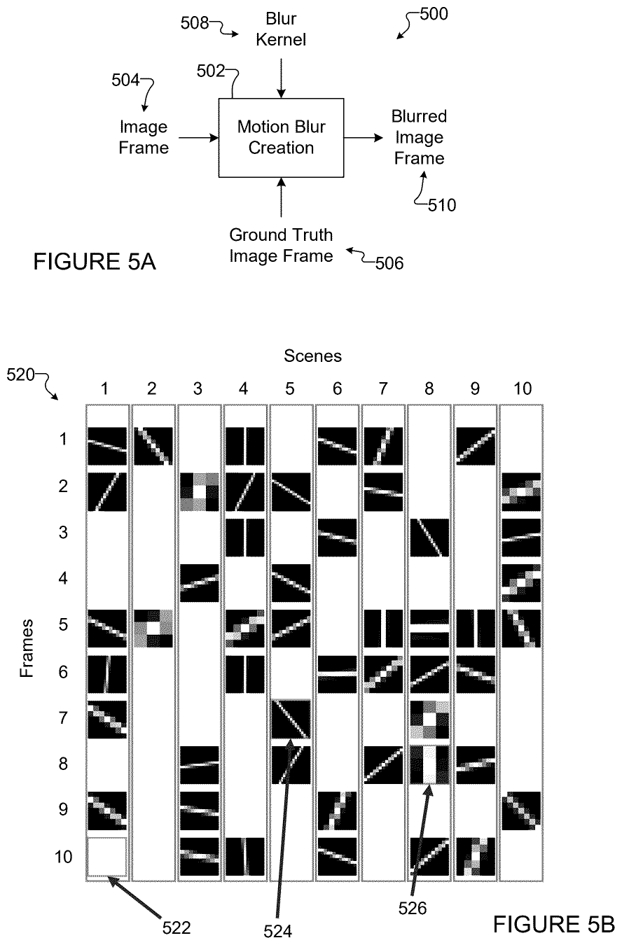

FIGS. 5A and 5B illustrate an example technique for applying motion blur in accordance with this disclosure. More specifically, FIGS. 5A and 5B illustrate an example function 500 for providing motion blur augmentation as part of the augmentation operation 306 shown in FIG. 3. For case of explanation, the function 500 shown in FIGS. 5A and 5B is described as being implemented on or supported by the server 106 in the network configuration 100 of FIG. 1. However, the function 500 shown in FIGS. 5A and 5B could be used with any other suitable device(s) and in any other suitable system(s), such as when the function 500 is implemented on or supported by the electronic device 101.

As shown in FIG. 5, the function 500 is implemented using a motion blur creation operation 502, which generally operates to receive an image frame 504, a ground truth image frame 506, and a blur kernel 508 as inputs. The image frame 504 may represent a training image frame in a set 302 of training image frames. The ground truth image frame 506 may represent part or all of a ground truth image 304 associated with that set 302 of training image frames. The blur kernel 508 may represent a filter or other mechanism designed to produce controllable blurring in the image frame 504. The function 500 here can be used to process all training image frames in each set 302 of training image frames using random blur kernels 508. This results in the generation of blurred image frames 510. In some cases, different blurred image frames 510 can be generated using different random blur kernels 508, such as blur kernels 508 having different orientations and/or strengths of motion. In some embodiments, blur kernels 508 may randomly range in size from 1×1 (indicating no blurring) up to 17×17.

Consistent with the description above, the motion blur creation operation 502 may process a ground truth image frame 506 in order to estimate the noise contained in the ground truth image frame 506. For each image frame 504 in the set 302 of training image frames associated with the ground truth image frame 506, the motion blur creation operation 502 can removed the identified noise from the image frame 504, apply the associated blur kernel 508 to the image frame 504, and add the identified noise back into the blurred image frame to produce a blurred image frame 510. This can help to preserve the noise structure of the image frames 504 when generating the blurred image frames 510. This may be particularly useful in situations where the image frames 504 contain large amounts of noise, such as with image frames captured during nighttime or other low-light image capture operations. Also, when the image frames 504 represent multi-color channel image frames, the blurring may be applied individually to each color channel in order to preserve the color filter pattern associated with the multi-color channel image frames.

In particular embodiments, the operation of the motion blur creation operation 502 may be defined as follows.

$$For i = 1 to {N}_{f r a m e s}$$

$${α}_{i} = \frac{{\sum }_{p}^{{N}_{p i x e l s}} {( {x}_{i} )}_{p}}{{\sum }_{p}^{{N}_{p i x e l s}} {( {x}_{G T} )}_{p}}$$

$${n}_{i} = {x}_{i} - {α}_{i} {x}_{G T}$$

$${x}_{i}^{′} = {h}_{i} * ( {x}_{i} - {n}_{i} ) + {n}_{i}$$

Here, N_{frames} represents the number of image frames 504 in a set 302 of training image frames being processed, Nₚᵢₓₑₗₛ represents a number of pixels in each image frame 504, and *(·) represents a 2D convolution. Also, xᵢ represents an original image frame 504, x_{GT} represents the associated ground truth image frame 506, and

$${x}_{i}^{′}$$

represents the associated blurred image frame 510. In addition, nᵢ represents an estimate of the noise in the original image frame 504 based on the associated ground truth image frame 506, and αᵢ∈ [symbol] represents a normalization of a possible scaling discrepancy of the associated ground truth image frame 506 x_{GT} (which may help to ensure that each nᵢ is zero-mean).

As noted above, the blur kernel 508 used with each image frame 504 can be randomly selected and can be defined based on (among other things) its orientation and/or strength of motion. In some embodiments, for each image frame 504 of a scene (a set 302 of training image frames), a random process may be utilized to determine (i) how motion is to be oriented and (ii) how strong the motion is, which allows the random process to define the blur kernel 508 for each image frame 504. FIG. 5B illustrates an example assignment 520 of random blur kernels to image frames 504 in different scenes (different sets 302 of training image frames). In this particular example, for instance, a blur kernel 522 may represent a 1×1 kernel, implying no blurring will occur. A blur kernel 524 may represent a large 17×17 kernel (implying strong blurring) that occurs in a diagonal direction. A blur kernel 526 may represent a small 3×3 kernel (implying mild blurring) that occurs in a vertical direction. The remaining kernels in the assignment 520 may define other random kernels to be applied.

In particular embodiments, the following algorithm may be used to randomly assign blur kernels 508 to image frames 504.

```
If Bernoulli(p_{blur}) == 1:
  size = Uniform({3, 5, 7, ..., MaxSize})
  angle = Uniform([0, π])
  h = MotionBlurKernel(size, angle)
else:
  h = [[1]] // Identity 1×1 kernel
```

Here, p_{blur} represents the probability of blurring occurring, and MaxSize represents the size of the largest possible blur kernel (which in some cases may equal 17). Also, MotionBlurKernel(·) represents a function that generates a motion blur kernel of size size and angle angle with a linear trajectory of motion.

Although FIGS. 5A and 5B illustrate one example of a technique for applying motion blur, various changes may be made to FIGS. 5A and 5B. For example, motion blur may be applied to image frames in any other suitable manner. Also, the specific blur kernels shown in FIG. 5B are for illustration only.

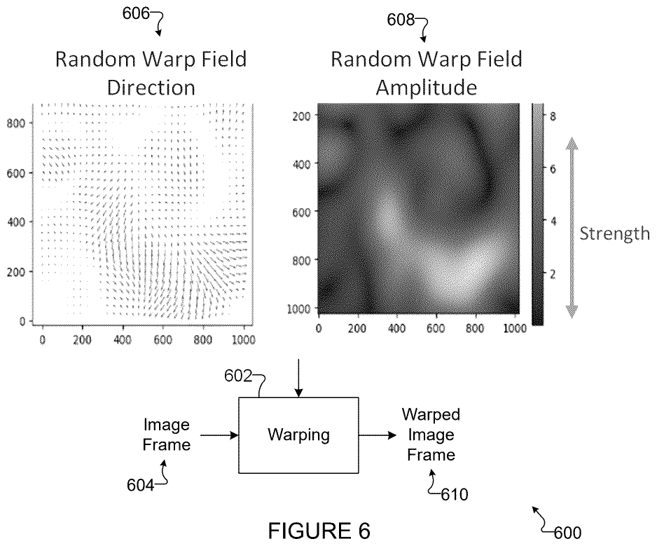

FIG. 6 illustrates an example technique for applying warping in accordance with this disclosure. More specifically, FIG. 6 illustrates an example function 600 for providing warping augmentation as part of the augmentation operation 306 shown in FIG. 3. For ease of explanation, the function 600 shown in FIG. 6 is described as being implemented on or supported by the server 106 in the network configuration 100 of FIG. 1. However, the function 600 shown in FIG. 6 could be used with any other suitable device(s) and in any other suitable system(s), such as when the function 600 is implemented on or supported by the electronic device 101.

As shown in FIG. 6, the function 600 is implemented using a warping operation 602, which generally operates to receive an image frame 604, a random warp field direction 606, and a random warp field amplitude 608 as inputs. The image frame 604 may represent a training image frame in a set 302 of training image frames (possibly as modified using the function 500 described above). The random warp field direction 606 may represent a random selection of the direction in which each pixel of the image frame 604 will be warped (if any). The random warp field amplitude 608 may represent a random selection of the strength/locality in which each pixel of the image frame 604 will be warped (if any). Collectively, the random warp field direction 606 and the random warp field amplitude 608 define a warp field that identifies the direction and amount of warping to be applied to the image frame 604. Applying this warp field to the image frame 604 results in the generation of a warped image frame 610.

In particular embodiments, the random warp field direction 606 and the random warp field amplitude 608 may be defined as follows.

$$For i = 1 to {N}_{f r a m e s}$$

$${W}_{0} = 𝒩 ( 0 , {I}_{N M , 2} )$$

$$W = \frac{{A}_{r} {W}_{0} s}{mean ( \vert {A}_{r} {W}_{0} \vert )} ∈ {ℝ}^{N M \times 2}$$

$${x}_{i}^{″} = BayerWarp ( {x}_{i}^{′} , W )$$

Here, for each image frame 604, a new random field of white Gaussian noise (W₀) can be generated. The random field of white Gaussian noise may have twice the width and twice the height of the image frame 604. A final warp field W can be generated by applying a linear 2D Gaussian blur operator A, and applying normalization so that the mean-average of the result is equal to s. Elements ((W)_{i,1}, (W)_{i,2}) can control the warp vector applied to pixel i in the (x, y) directions, respectively. The parameter r≥0 represents the radius of the Gaussian blur and can be used to control the locality of the warp augmentation. For example, when r=0, Aᵣ=1, and all pixels are warped independently. When r>>0, all pixels in a neighborhood of radius r are warped in approximately the same direction and distance. The parameter s≥0 can be used to control the strength of the average warp distance. The parameters r and s can be tuned to achieve the best image quality. In addition,

$${x}_{i}^{″}$$

represents the warped image frame 610.

In some cases, the warp fields applied to image frames 604 within each set 302 of training image frames can be random. Also, in some cases, warp fields are applied only to a subset (and not all) of the image frames 604 within each set 302 of training image frames, such as when one specified image frame 604 within each set 302 of training image frames is not warped and all other image frames 604 within each set 302 of training image frames are warped. As a particular example, the first image frame 604 within each set 302 of training image frames may not be warped. In addition, when the image frames 604 represent multi-color channel image frames, the warping may be applied to the color channels using a Bayer-specific warping algorithm or other color filter array-specific warping algorithm. For instance, in some embodiments, warped pixel positions may be demosaiced and interpolated to preserve the details and noise of the original image frame 604. In other embodiments, a Bayer or other color filter pattern can be demosaiced (such as into RGB), each demosaiced color channel can be warped independently, and the warped color channels can be remosaiced (such as by applying a color filter array operation).

Although FIG. 6 illustrates one example of a technique for applying warping, various changes may be made to FIG. 6. For example, warping may be applied to image frames in any other suitable manner. Also, the specific random warp field direction 606 and the specific random warp field amplitude 608 shown in FIG. 6 are for illustration only.

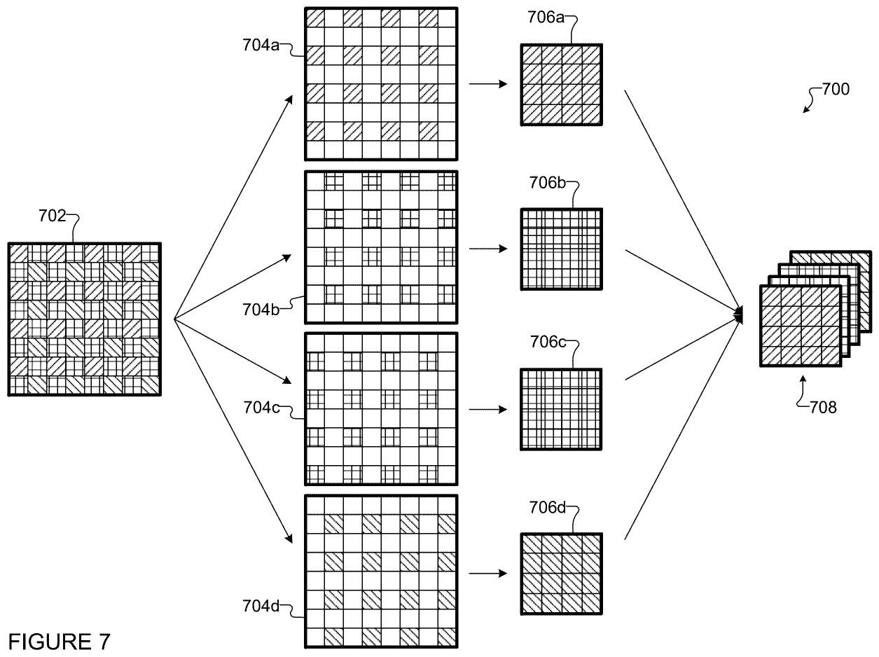

FIGS. 7 through 9 illustrate example processing of multi-color channel image frames during training and use of a machine learning model in accordance with this disclosure. In some embodiments, various image frames described above may represent multi-color channel image frames, meaning each of the image frames includes multiple color channels. One example of this involves Bayer image frames, which include a red, blue, and green color filter array. In a standard Bayer color filter array, there are twice as many green pixels as red pixels or blue pixels. The following describes how multi-color channel image frames could be processed to support motion blur augmentation and warping augmentation. However, other techniques may be used to support motion blur augmentation and warping augmentation using multi-color channel image frames.

As shown in FIG. 7, a channel stacking process 700 is illustrated. In this example, an image frame 702 has a Bayer color filter array pattern in which 2×2 collections of pixels each includes one red pixel, one blue pixel, and two green pixels. The channel stacking process 700 separates the image frame 702 into multiple isolated image color channels 704a-704d, where each isolated image color channel 704a-704d includes pixels of a single color and position within the repeating pattern of the image frame 702. Removing blank pixels from the isolated image color channels 704a-704d leads to the creation of compressed color channels 706a-706d, each of which is again associated with pixels of a single color. The compressed color channels 706a-706d can be grouped to form a color channel stack 708 associated with the image frame 702. In some embodiments, the image frame 702 may have dimensions of 2N×2N, and the color channel stack 708 may have dimensions of N×N×4. The N×N×4 notation indicates that there are four channels each having half the width and half the height of the 2N×2N image frame 702.

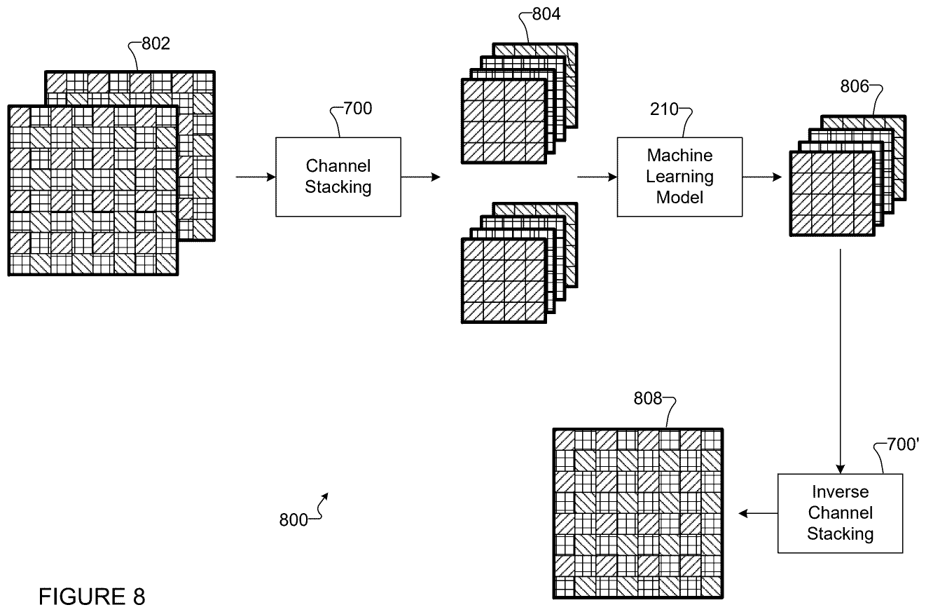

As shown in FIG. 8, during inferencing using the machine learning model 210, multiple image frames 802 can be obtained, and each image frame 802 can have a Bayer or other color filter array pattern. In some cases, for example, the image frames 802 may represent the input image frames 202 and can capture a single scene, possibly using different exposure settings. The channel stacking process 700 can be used to convert each image frame 802 into a corresponding color channel stack 804. The color channel stacks 804 can be provided as inputs to the trained machine learning model 210, and the trained machine learning model 210 can generate a color channel stack 806 associated with a blended image. An inverse channel stacking process 700′ can be performed on the color channel stack 806 to reverse the channel stacking process 700 shown in FIG. 7. This results in the generation of a blended image 808, which again can have a Bayer or other color filter array pattern. For instance, the blended image 808 may represent a blended image 214.

Note that the number of image frames 802 used here may be denoted K. In some embodiments, K≈10, and this number of image frames (resulting from handheld image capture) may be likely perturbed by noise, motion blur, and slight misalignment from registration errors. In some embodiments, each image frame 802 may have dimensions of 2N×2N, each color channel stack 804 and 806 may have dimensions of N×N×4, and the blended image 808 may have dimensions of 2N×2N. This approach allows Bayer or other multi-color channel image frames to be rearranged and processed, and the resulting output can be arranged back into the Bayer or other format.

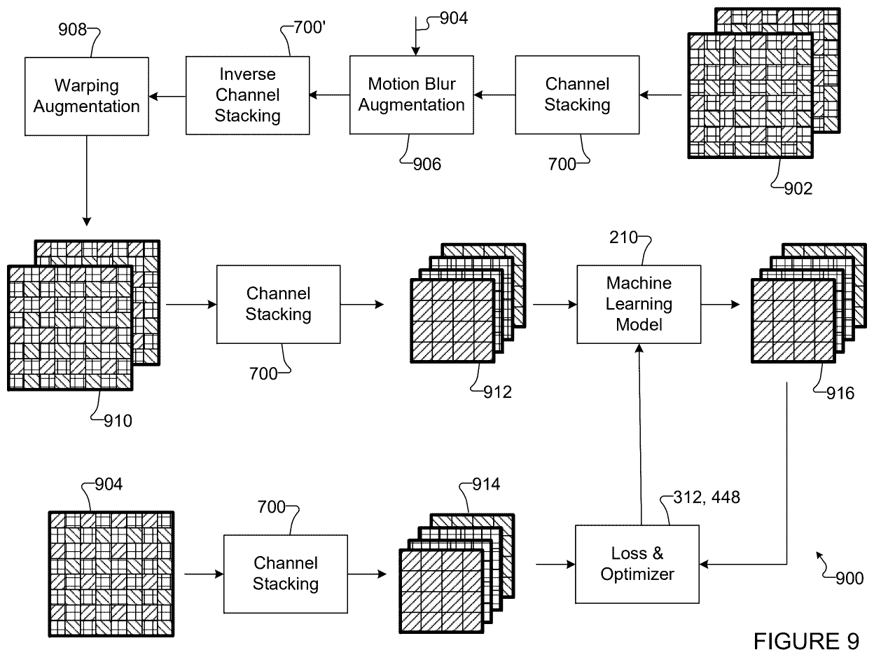

As shown in FIG. 9, during training of the machine learning model 210, multiple image frames 902 (which may represent image frames contained in a set 302 of training image frames) and an associated ground truth image frame 904 (which may represent a ground truth image 304 or portion thereof) can be obtained. Each image frame 902 and 904 can have a Bayer or other color filter array pattern. Each image frame 902 can be processed using the channel stacking process 700, which can convert each image frame 902 into a corresponding color channel stack. Each of the color channel stacks can be processed using a motion blur augmentation operation 906 based on the ground truth image frame 904, where motion blur augmentation can occur within each color channel of each color channel stack. The inverse channel stacking process 700′ can be used to convert the modified color channel stacks back into multi-color channel image frames, and the multi-color channel image frames can be processed using a warping augmentation operation 908. The operations 906 and 908 here may be implemented as part of the augmentation operation 306 described above. Resulting augmented image frames 910 can be processed using the channel stacking process 700, which can convert each augmented image frame 910 into a corresponding color channel stack 912. The channel stacking process 700 can also be used to convert the ground truth image frame 904 into a corresponding color channel stack 914.

The color channel stacks 912 can be provided as inputs to the machine learning model 210 being trained, and the machine learning model 210 can generate a color channel stack 916 associated with a blended image. The loss computation operation 312 and optimizer 448 can determine a loss for the machine learning model 210 based on differences between the color channel stacks 914 and 916 and can update weights or other parameters of the machine learning model 210. As described above, this can occur repeatedly until one or more criteria are satisfied.

As can be seen here, the image frames 902 can be pre-processed through the motion blur and warping augmentations and rearranged through channel stacking and inverse channel stacking as needed to be suitable for processing by the machine learning model 210. The same channel stacking can be applied to the ground truth image frame 904 in order to enable computation of the loss and updating of the weights of the machine learning model 210 iteratively during training.

In some embodiments, the image frames 902 may include a collection of K image frames, such as K≈10 noisy Bayer or other multi-color channel image frames. The image frames 902 can capture a static scene and can be augmented using simulated motion blur and warping augmentations. In particular embodiments, each image frame 902, 904 may have dimensions of 2N×2N, and each color channel stack 912, 914, 916 may have dimensions of N×N×4. The contributions for each of the K image frames 902 can therefore be stacked in this manner so that the final input tensor to the machine learning model 210 can have dimensions of N×N×4K. Note that this process may occur repeatedly using any number of sets of image frames 902 and ground truth image frames 904 to train the machine learning model 210.

Although FIGS. 7 through 9 illustrate examples of processing of multi-color channel image frames during training and use of a machine learning model 210, various changes may be made to FIGS. 7 through 9. For example, multi-color channel image frames may be processed in any other suitable manner during training and use of the machine learning model 210.

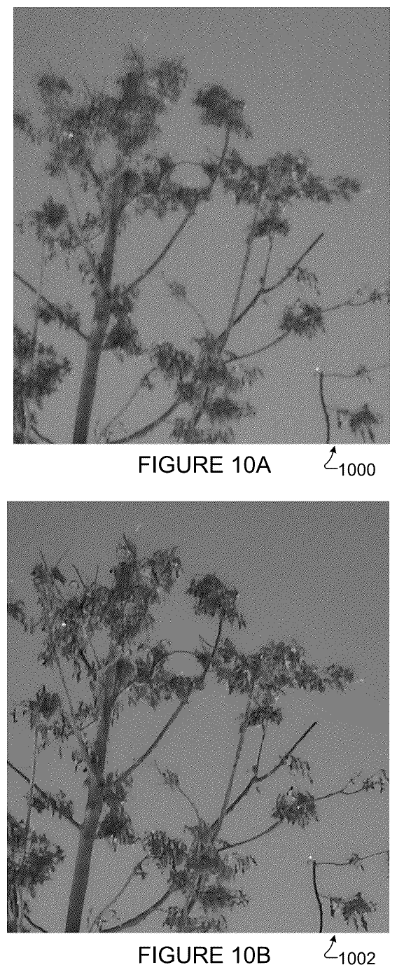

FIGS. 10A and 10B illustrate example results obtainable using a machine learning model 210 trained to perform multi-frame blending with simulated warping and handheld motion augmentations in accordance with this disclosure. More specifically, FIG. 10A illustrates an example output image 1000 generated using a multi-frame blending approach in which image data in input image frames undergoes weighted averaging to generate a blended image. As can be seen here, even though the input image frames may undergo pre-processing and alignment, the output image 1000 can still appear blurry. Among other reasons, this can be due to residual misalignment and motion blur that remains in the input image frames after the pre-processing and alignment.

FIG. 10B illustrates an example output image 1002 generated using a machine learning model 210 trained as described above using simulated warping and handheld motion augmentations. As can be seen here, the resulting output image 1002 provides better results compared to simply performing weighted averaging of image data. Among other reasons, this can be due to the machine learning model 210 being effectively trained to remove motion blur and misalignment.

Although FIGS. 10A and 10B illustrate one example of results obtainable using a machine learning model 210 trained to perform multi-frame blending with simulated warping and handheld motion augmentations, various changes may be made to FIGS. 10A and 10B. For example, FIGS. 10A and 10B are merely meant to illustrate one example of a type of benefit that might be obtained using the techniques of this disclosure. The specific results that are obtained in any given situation can vary based on the circumstances and based on the specific implementation of the techniques described in this disclosure.

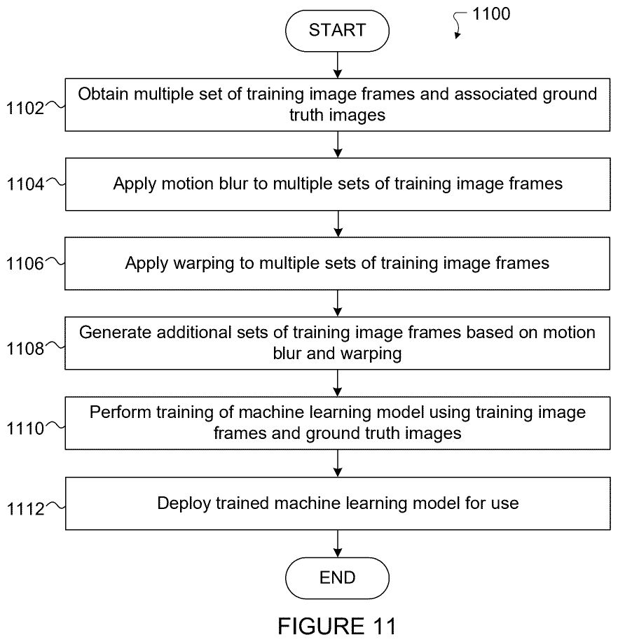

FIG. 11 illustrates an example method 1100 for training a machine learning model to perform multi-frame blending with simulated warping and handheld motion augmentations in accordance with this disclosure. For case of explanation, the method 1100 shown in FIG. 11 is described as being performed by the server 106 in the network configuration 100 of FIG. 1, where the server 106 can implement one of the architectures 300, 400 shown in FIGS. 3 and 4. However, the method 1100 shown in FIG. 11 could be performed by any other suitable device(s) and architecture(s) and in any other suitable system(s), such as when the method 1100 is performed using the electronic device 101.

As shown in FIG. 11, multiple sets of training image frames and associated ground truth images are obtained at step 1102. This may include, for example, the processor 120 of the server 106 obtaining multiple sets 302 of training image frames, where each set 302 of training image frames is associated with a ground truth image 304. The training image frames and ground truth images can be obtained from any suitable source(s), including one or more public or proprietary sources.

Motion blur is applied to the training image frames at step 1104, and warping is applied to the training image frames at step 1106. This may include, for example, the processor 120 of the server 106 performing the augmentation operation 306 (which may include the motion blur augmentation operation 906 and the warping augmentation operation 908) to apply motion blur and warping to the training image frames in each set 302 of training image frames. This leads to the generation of additional sets of training image frames at step 1108. This may include, for example, the processor 120 of the server 106 generating augmented sets 308 of training image frames based on the applied motion blur and warping.

Training of a machine learning model is performed using at least some of the training image frames and at least some of the ground truth images at step 1110. This may include, for example, the processor 120 of the server 106 providing at least some of the augmented sets 308 of training image frames and optionally at least some of the sets 302 of training image frames to the machine learning model 210 and generating blended images 310 using the machine learning model 210. This may also include the processor 120 of the server 106 performing the loss computation operation 312 to calculate the loss associated with the machine learning model 210 based on the blended images 310 and the associated ground truth images 304. This may further include the processor 120 of the server 106 performing the update process 314, such as by using the optimizer 448, in order to update weights or other parameters of the machine learning model 210. Note that any suitable number of training iterations may occur here involving the training image frames and the ground truth images.

Once suitably trained, the machine learning model can be deployed for use at step 1112. This may include, for example, the processor 120 of the server 106 placing the trained machine learning model 210 into use by the server 106 itself and/or providing the trained machine learning model 210 to one or more other devices (such as the electronic device 101) for use.

Although FIG. 11 illustrates one example of a method 1100 for training a machine learning model to perform multi-frame blending with simulated warping and handheld motion augmentations, various changes may be made to FIG. 11. For example, while shown as a series of steps, various steps in FIG. 11 may overlap, occur in parallel, occur in a different order, or occur any number of times (including zero times). As a particular example, various ones of the steps 1102-1110 may occur repeatedly during different training iterations of the machine learning model 210.

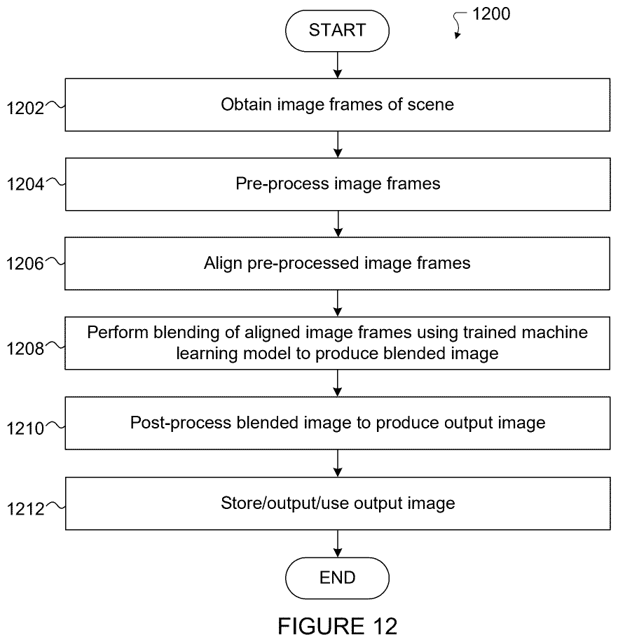

FIG. 12 illustrates an example method 1200 for using a trained machine learning model to perform multi-frame blending in accordance with this disclosure. For case of explanation, the method 1200 shown in FIG. 12 is described as being performed by the electronic device 101 in the network configuration 100 of FIG. 1, where the electronic device 101 can implement the pipeline 200 shown in FIG. 2. However, the method 1200 shown in FIG. 12 could be performed by any other suitable device(s) and pipeline(s) and in any other suitable system(s), such as when the method 1200 is performed using the server 106.

As shown in FIG. 12, image frames of a scene are obtained at step 1202. This may include, for example, the processor 120 of the electronic device 101 generating or otherwise obtaining multiple image frames 202 of the scene, such as by initiating a capture operation to capture the image frames 202 using one or more imaging sensors 180 of the electronic device 101. The image frames can be pre-processed at step 1204. This may include, for example, the processor 120 of the electronic device 101 pre-processing the image frames 202 using the pre-processing operation 204, such as to perform white balancing and/or denoising. The image frames can be aligned with one another at step 1206. This may include, for example, the processor 120 of the electronic device 101 performing the image frame alignment operation 206.

Blending of the aligned image frames is performed using a trained machine learning model at step 1208. This may include, for example, the processor 120 of the electronic device 101 processing the aligned image frames 212 using a machine learning model 210. In some cases, the machine learning model 210 may represent a machine learning model that is trained as described above. The machine learning model 210 can be trained to generate a blended image 214 based on the aligned image frames 212 while accounting for residual misalignment and motion blur that remains in the aligned image frames 212. The blended image may undergo post-processing to generate an output image at step 1210. This may include, for example, the processor 120 of the electronic device 101 post-processing the blended image 214 using the post-processing operation 216, such as to perform tone-mapping and/or demosaicing. This can result in the generation of an output image 218.

The output image is stored, output, or used in some manner at step 1212. For example, the output image 218 may be displayed on the display 160 of the electronic device 101, saved to a camera roll stored in a memory 130 of the electronic device 101, or attached to a text message, email, or other communication to be transmitted from the electronic device 101. Of course, the output image 218 could be used in any other or additional manner.

Although FIG. 12 illustrates one example of a method 1200 for using a trained machine learning model 210 to perform multi-frame blending, various changes may be made to FIG. 12. For example, while shown as a series of steps, various steps in FIG. 12 may overlap, occur in parallel, occur in a different order, or occur any number of times (including zero times).

It should be noted that the functions described above can be implemented in an electronic device 101, 102, 104, server 106, or other device(s) in any suitable manner. For example, in some embodiments, at least some of the functions can be implemented or supported using one or more software applications or other software instructions that are executed by the processor 120 of the electronic device 101, 102, 104, server 106, or other device(s). In other embodiments, at least some of the functions can be implemented or supported using dedicated hardware components. In general, the functions described above can be performed using any suitable hardware or any suitable combination of hardware and software/firmware instructions. Also, the functions described above can be performed by a single device or by multiple devices.

Although this disclosure has been described with example embodiments, various changes and modifications may be suggested to one skilled in the art. It is intended that this disclosure encompass such changes and modifications as fall within the scope of the appended claims.

What is claimed is:

1. A method comprising:
obtaining, using at least one processing device of an electronic device, multiple sets of training image frames, each set of training image frames having an associated ground truth image;
applying, using the at least one processing device, motion blur and warping to the multiple sets of training image frames in order to generate additional sets of training image frames; and
training, using the at least one processing device, a machine learning model to align image frames and remove motion blur from the image frames based on at least the additional sets of training image frames and the ground truth images.

2. The method of claim 1, wherein applying the motion blur comprises, for each set of training image frames:
identifying noise in the associated ground truth image;
removing the identified noise from the training image frames in the set of training image frames in order to generate denoised image frames;
applying one or more random blur kernels to each of the denoised image frames in order to generate blurred image frames; and
adding the identified noise to the blurred image frames.

3. The method of claim 2, wherein:
each of the training image frames comprises image data in multiple color channels; and
the one or more random blur kernels are applied to each color channel of each training image frame.

4. The method of claim 2, wherein applying the one or more random blur kernels to each of the denoised image frames comprises:
selecting an orientation and strength of motion to be created in each of the denoised image frames; and
defining the one or more random blur kernels for each of the denoised image frames based on the corresponding orientation and strength of motion.

5. The method of claim 1, wherein applying the warping comprises, for each set of training image frames:
generating a warp field for each of a subset of the training image frames; and
applying the generated warp fields to the subset of the training image frames; and
wherein each warp field defines that each pixel of an image frame is warped independently of other pixels but neighboring pixels of the image frame are warped with a same or similar direction and a same or similar strength.

6. The method of claim 5, wherein generating the warp field for each of the subset of the training image frames comprises:
generating white Gaussian noise; and
applying a linear two-dimensional (2D) Gaussian blur operator and normalization to the white Gaussian noise.

7. The method of claim 1, wherein:
the training image frames capture different static scenes;
the ground truth images comprise long-exposure images of the static scenes; and
the additional sets of training image frames simulate inter-frame motion and inter-frame misalignment.

8. An apparatus comprising:
at least one processing device configured to:
obtain multiple sets of training image frames, each set of training image frames having an associated ground truth image;
apply motion blur and warping to the multiple sets of training image frames in order to generate additional sets of training image frames; and
train a machine learning model to align image frames and remove motion blur from the image frames based on at least the additional sets of training image frames and the ground truth images.

9. The apparatus of claim 8, wherein, to apply the motion blur, the at least one processing device is configured, for each set of training image frames, to:
identify noise in the associated ground truth image;
remove the identified noise from the training image frames in the set of training image frames in order to generate denoised image frames;
apply one or more random blur kernels to each of the denoised image frames in order to generate blurred image frames; and
add the identified noise to the blurred image frames.

10. The apparatus of claim 9, wherein:
each of the training image frames comprises image data in multiple color channels; and
the at least one processing device is configured to apply the one or more random blur kernels to each color channel of each training image frame.

11. The apparatus of claim 9, wherein, to apply the one or more random blur kernels to each of the denoised image frames, the at least one processing device is configured to:
select an orientation and strength of motion to be created in each of the denoised image frames; and
define the one or more random blur kernels for each of the denoised image frames based on the corresponding orientation and strength of motion.

12. The apparatus of claim 8, wherein, to apply the warping, the at least one processing device is configured, for each set of training image frames, to:
generate a warp field for each of a subset of the training image frames; and
apply the generated warp fields to the subset of the training image frames; and
wherein each warp field defines that each pixel of an image frame is warped independently of other pixels but neighboring pixels of the image frame are warped with a same or similar direction and a same or similar strength.

13. The apparatus of claim 12, wherein, to generate the warp field for each of the subset of the training image frames, the at least one processing device is configured to:
generate white Gaussian noise; and
apply a linear two-dimensional (9D) Gaussian blur operator and normalization to the white Gaussian noise.

14. The apparatus of claim 8, wherein:
the training image frames capture different static scenes;
the ground truth images comprise long-exposure images of the static scenes; and
the additional sets of training image frames simulate inter-frame motion and inter-frame misalignment.

15. A method comprising:
obtaining, using at least one processing device of an electronic device, a set of input image frames capturing a scene;
processing, using the at least one processing device, the set of input image frames using a trained machine learning model to align the input image frames and reduce motion blur in the input image frames in order to generate processed image frames; and
generating, using the at least one processing device, an output image of the scene using the processed image frames;
wherein the trained machine learning model is trained by:
obtaining multiple sets of training image frames, each set of training image frames having an associated ground truth image;
applying motion blur and warping to the multiple sets of training image frames in order to generate additional sets of training image frames; and
training the machine learning model based on at least the additional sets of training image frames and the ground truth images.

16. The method of claim 15, wherein applying the motion blur comprises, for each set of training image frames:
identifying noise in the associated ground truth image;
removing the identified noise from the training image frames in the set of training image frames in order to generate denoised image frames;
applying one or more random blur kernels to each of the denoised image frames in order to generate blurred image frames; and
adding the identified noise to the blurred image frames.

17. The method of claim 16, wherein:
each of the training image frames comprises image data in multiple color channels; and
the one or more random blur kernels are applied to each color channel of each training image frame.

18. The method of claim 16, wherein applying the one or more random blur kernels to each of the denoised image frames comprises:
selecting an orientation and strength of motion to be created in each of the denoised image frames; and
defining the one or more random blur kernels for each of the denoised image frames based on the corresponding orientation and strength of motion.

19. The method of claim 15, wherein applying the warping comprises, for each set of training image frames:
generating a warp field for each of a subset of the training image frames; and
applying the generated warp fields to the subset of the training image frames; and
wherein each warp field defines that each pixel of an image frame is warped independently of other pixels but neighboring pixels of the image frame are warped with a same or similar direction and a same or similar strength.

20. The method of claim 19, wherein generating the warp field for each of the subset of the training image frames comprises:
generating white Gaussian noise; and
applying a linear two-dimensional (2D) Gaussian blur operator and normalization to the white Gaussian noise.
